(19) United States
(12) Patent Application Publication
(10) Pub. No.: US 2025/0277345 A1
(43) Pub. Date: Sep. 4, 2025

(54) DEVICE FOR CONNECTING A SHIP TO A SHORE-SIDE SUPPLY NETWORK

(71) Applicant: Stemmann-Technik GmbH, Schüttorf (DE)

(72) Inventor: Christophe Gaigneux, Pontcharra (FR)

(73) Assignee: Stemmann-Technik GmbH, Schüttorf (DE)

(21) Appl. No.: 18/917,750

(22) Filed: Oct. 16, 2024

(30) Foreign Application Priority Data
Oct. 16, 2023 (DE) 102023128281.6

(51) Int. Cl. E01D 15/24

(52) U.S. Cl. CPC E01D 15/24

(57) ABSTRACT

A device 1 for connecting a ship to a shore-side supply network, comprising a passenger bridge 4, wherein the passenger bridge 4 is permanently arranged on a shore-side quay 5, wherein a power supply cable 9 for supplying the ship 2 with shore-side power during the ship's handling is arranged on the passenger bridge 4, and with a transfer device 10 ifor guiding a coupling unit 12 connected to the power supply cable 9 to a ship-side coupling unit.

The invention relates to a device for connecting a ship to a shore-side supply network according to the features of claim 1.

Seagoing ships need energy in the port for the operation of the ship on-board systems. The supply of external electricity, so-called onshore electricity, during the berth period is carried out via cables from a power source of a shore-side supply network at the quay to an on-board socket. The connected power of some types of ships, such as cruise ships, is extremely high and amounts to several MW, which requires high investment in infrastructure. On the other hand, the berth period and thus the connection time is rarely longer than 24 hours, i.e. the price per kilowatt-hour of electrical energy is relatively high, so that the investment in the infrastructure pays off. The prior art provides that connection points for electrical cables are arranged underground in the region of the quay in order to protect the connections from falling objects if they are not required. Open power cables would be an obstacle for vehicles of all kinds. They cannot be run over, must not be damaged and have large cross-sections and a considerable weight. The handling of these supply cables is therefore predominantly mechanized. Irrespective of the device provided for transferring the plug from land on board, however, there is always the problem that the transfer point varies depending on the type of ship and the berthing position, with the result that the power supply cables are often unprotected on the quay and represent an obstacle.

It is an object of the invention to provide a device for connecting a ship to a shore-side supply network, in which the power supply cables need not be routed over the quay as far as possible, or only along a very short route, so that they can be bypassed.

The invention achieves this object by means of a device having the features of claim 1.

The dependent claims refer to advantageous developments of the invention.

The device according to the invention is used to connect a ship to a shore-side supply network. It comprises a passenger bridge. In particular, the ship is provided for transporting persons, in particular it is a cruise ship. The passenger bridge is permanently located on the shore side of the quay. Such passenger bridges usually have electromechanical lifting systems in the supporting columns, which enable a boarding height of in some cases over 10 m above sea level. The passenger bridges can move longitudinally, transversely and also in the vertical direction in order to compensate for tidal ranges or positional changes during the maneuvering of the ship and a rolling of the ship. The invention uses these properties of the passenger bridge by using the passenger bridge to arrange a power supply cable for supplying the ship directly on the passenger bridge.

Since passenger bridges can have a considerable length, in some cases more than 50 m, it is also possible to bridge a considerable distance from the power supply cable to the ship by means of the passenger bridges. The device according to the invention also provides a transfer device for guiding a coupling unit connected to the power supply cable to a coupling unit on board the ship. The term coupling unit covers both plugs and plug-in couplings. A coupling unit can comprise a plurality of plugs and/or plug-in couplings. Therefore, several power supply cables can also be provided.

The invention has the advantage that the transfer device does not have to be connected to underground connection points for the supply cables. Also, the power supply cable generally does not have to be laid underground. The power supply cable at the passenger bridge thus makes it possible to avoid structural interventions at the quay.

The transfer device is used for handling the relatively heavy shore-side coupling unit/plug, in particular since the ship-side connection points are often several meters above sea level.

In a first embodiment of the invention, the transfer device is carried by the passenger bridge. This means that the transfer device itself is fastened to the passenger bridge. The transfer device is particularly preferably arranged underneath the passenger bridge.

A transfer device in this sense has movable modules, in particular a displaceable arm, for transferring the coupling unit/plug. The transfer can take place at a considerable height above sea level or above the quay, so that vehicles on the quay can easily pass underneath the area of the passenger bridge. In addition, the transfer device preferably does not extend beyond the length of the passenger bridge, but can be arranged at the front end of the passenger bridge or can even be displaced together with the front end of the passenger bridge when the passenger bridge is extended. Alternatively or additionally, the distance to the ship can be bridged by the displaceable arm. Preferably, the passenger bridge is first placed and in the second step the shore-side power connection is established.

A further advantage of the invention is that, in the case of a passenger bridge, a tracking always takes place in adaptation to the movement of the ship. This tracking is also required for shore-side power supply, so that the coupling units and power supply cables are not overloaded. According to the invention, the tracking of the passenger bridge integrated into the passenger bridge can also be used to track the shore-side power supply, in the sense that no two independently operating systems are required. The closer the ship-side coupling unit is arranged to the ship-side transition of the passenger bridge, the smaller the deviations between these two points are when the ship moves, for example rolls. In principle, the supply cables are provided with a sufficient length so that any movements of the ship can be compensated. The coupling devices are held in strain relief systems after coupling.

In an alternative embodiment of the invention, a transfer point of the power supply cable for connection to a transfer device, which can be positioned on the quay in a mobile manner, is located on the passenger bridge. Apart from the connected power supply cable, a transfer device which can be positioned on the quay in a mobile manner is not mechanically fixedly connected to the passenger bridge, but can be moved on the quay independently of the passenger bridge. The transfer device has a chassis for this purpose. However, the special feature of this transfer device is that it is or will be connected to the passenger bridge, i.e. that the transfer point for the power supply is arranged on the passenger bridge. In this case, too, the shore-side power supply cable is located at the passenger bridge and extends up to near the ship without interfering with the structure of the quay. At the same time, this means that a connection between the transfer device and the transfer point of the power supply cable can be comparatively short. The transfer point at the passenger bridge is preferably located underneath the passenger bridge in weather-protected manner. The transfer point can be arranged, for example, on a supporting structure, for example on a chassis of the passenger bridge, so that no lifting means are required to connect the transfer point to the transfer device. A special feature of the device according to the invention is therefore that the transfer point can be displaced together with the passenger bridge, at least in the longitudinal direction of the quay, when the passenger bridge is displaced in the longitudinal direction of the quay.

The transfer device preferably has at least one controllable arm for guiding the shore-side coupling unit to the ship-side coupling unit. The ship-side coupling unit can be arranged at a height of several meters above sea level, so that it is not readily accessible from the quay level. The mobile transfer device increases the radius of action of the device according to the invention, so that coupling units on the ship side can also be reached at a greater distance from the passenger bridge, in particular those which cannot be reached with an arm below the passenger bridge. The invention also provides for the possibility of using one or the other transfer device, depending on the type of ship, i.e. there is a transfer device which is carried by the passenger bridge and a second mobile transfer device

The device according to the invention is used to supply ships with energy, in particular electricity. The invention includes the possibility of connecting further supply cables. This is understood as meaning, for example, data lines in order to connect the ship to a shore-side communication network. The device can be expanded to the effect that additional supply cables can be connected in this manner. The additional supply cables can also be pipelines which are used for the transport of fluids and pourable or pumpable solids as well as for the transmission of mechanical and thermal energy. The term supply cable includes the fact that the supply can take place in both directions, i.e. from the water side to the shore side and from the shore side to the water side.

In the following, the invention will be described in greater detail in reference to two exemplary embodiments purely schematically illustrated in the drawings. In particular

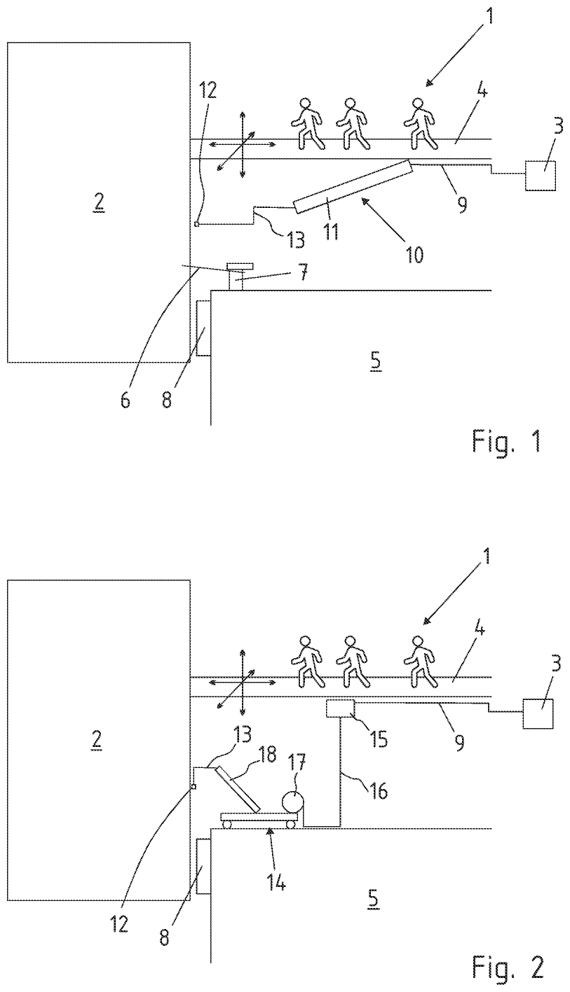

FIG. 1 shows a first embodiment of a device according to the invention with a transfer device on the passenger bridge and

FIG. 2 shows a second embodiment of the device according to the invention with a separate mobile transfer device.

FIG. 1 shows a device 1 for connecting a ship 2 to a shore-side supply network 3. The shore-side supply network 3 is represented here purely symbolically and in particular provides electrical energy in the form of shore-side electricity.

The device 1 further comprises a passenger bridge 4 which is permanently fixed on the shore side on a quay 5. The arrows on the passenger bridge 4 make it clear that its ship-side end can be displaced in all spatial directions in order to compensate for movements of the ship 2 during handling and due to environmental influences. The handling of the ship 2 only takes place when ship 2 is moored at quay 5. A mooring line 6 at a bollard 7 and a fender 8 between the quay and the ship symbolically indicate that the ship has moored.

FIG. 1 shows that a power supply cable 9 is arranged beneath the passenger bridge 4 and is connected to the shore-side supply network 3. This power supply cable 9 leads to a transfer device 10 with a displaceable arm 11. The transfer device 10 serves to convey a coupling unit 12 at the end of a connecting cable 13 to a ship-side coupling unit, not shown in detail, so that the ship 2 can be connected to the shore-side supply network 3. The special feature is that the power supply cable 9 does not run in or on the surface of the shore-side quay 5, but at a height at which traffic can pass underneath the passenger bridge 4. In this way, the power supply cable 9 is protected against damage. At the same time, the transfer device 10 is also moved together with the movement of the passenger bridge 4 to compensate for ship movements. Therefore, no additional compensating elements are required at the transfer device 10, apart from a loop which is always present in the connecting cable 13, in order to compensate for residual movements and to enable handling, in particular in the case of manual coupling.

The exemplary embodiment of FIG. 2 differs from that of FIG. 1 by a mobile transfer device 14 which replaces the stationary transfer device 10 in FIG. 1. The reference numerals introduced in FIG. 1 are also used in FIG. 2 for essentially functionally identical components.

The power supply cable 9, which is connected to the shore-side supply network 3, ends at a transfer point 15. This transfer point 15 is connected to the mobile transfer device 14 via a connecting cable 16. A cable drum 17 of the transfer device 14 releases the necessary length of connecting cable 16. Depending on the position of the mobile transfer device 14 on the quay 5, the connecting cable 16 is more or less wound up. The transfer device 14 has an arm 18, shown purely schematically, which extends in the direction of the ship 2. The terminal coupling unit 12 for connection to the ship-side coupling unit is also located on the connecting cable 13. When the ship 2 departs, the passenger bridge 4 is moved back. The shore-side power supply can also be terminated, and the mobile transfer device 14, which has a chassis for traveling on the quay, is moved back.

Both embodiments, i.e. the one with a transfer device 10 on the passenger bridge 4 and the one with a mobile transfer device 14 on the quay 5, have the advantage that the power supply cable 9 does not have to be embedded in the quay 5 or has to lie on the surface of the quay 5. The power supply cable 9 is maximally protected against damage and does not impede operation on the quay.

### REFERENCE NUMERALS

1—device
2—ship
3—shore-side supply network
4—passenger bridge
5—quay
6—mooring line
7—bollards
8—fender
9—power supply cable
10—transfer device
11—arm
12—shore-side coupling unit
13—connecting cable
14—mobile transfer device
15—transfer point
16—connecting cable between 14 and 15
17—cable drum
18—arm

1. A device (1) for connecting a ship to a shore-side supply network, comprising a passenger bridge (4), wherein the passenger bridge (4) is permanently arranged on a shore-side quay (5), wherein a power supply cable (9) for supplying the ship (2) with shore-side power during the ship's handling is arranged on the passenger bridge (4), and with a transfer device (10, 14) for guiding a coupling unit (12) connected to the power supply cable (9) to a ship-side coupling unit.

2. The device (1) according to claim 1, characterized in that the transfer device (10) is carried by the passenger bridge (4).

3. The device (1) according to claim 2, characterized in that the transfer device (10) is arranged beneath the passenger bridge (4).

4. The device (1) according to claim 1, characterized in that a transfer point (15) of the power supply cable (9) for connection to the transfer device (15) is arranged on the passenger bridge (4), wherein the transfer device (14) can be positioned in a mobile manner on the quay (5).

5. The device (1) according to any one of claims 1 to 4, characterized in that the transfer device (10, 14) has at least one controllable arm (11) in order to guide the shore-side coupling unit (12) to the ship-side coupling unit.
